(19) United States
(12) Patent Application Publication
(10) Pub. No.: US 2013/0122152 A1
(43) Pub. Date: May 16, 2013

(54) READY TO DRINK BEVERAGES

(71) Applicants: Teresita Bautista Pascual, Marysville, OH (US); Monica Christina Valdez, Columbus, OH (US); Alexander A. Sher, Dublin, OH (US)

(72) Inventors: Teresita Bautista Pascual, Marysville, OH (US); Monica Christina Valdez, Columbus, OH (US); Alexander A. Sher, Dublin, OH (US)

(73) Assignee: NESTEC S.A., Vevey (CH)

(21) Appl. No.: 13/518,293

(22) PCT Filed: Dec. 8, 2010
(86) PCT No.: PCT/EP10/69180

§ 371 Date: Aug. 9, 2012

(30) Foreign Application Priority Data
Dec. 21, 2009 (US) PCT/US2009/068947

(51) Int. Cl. A23G 1/56

(52) U.S. Cl. CPC A23G 1/56
USPC 426/71; 426/593; 426/72

(57) ABSTRACT

Ready to drink beverages are provided. In a general embodiment, the present disclosure provides a ready to drink beverage including water, a cocoa component, and a stabilizing system. The stabilizing system has a cellulose component including a blend of microcrystalline cellulose and carboxymethylcellulose in an amount ranging from about 0.03% to about 1% by weight, a gum, and an emulsifier ranging from about 0.09% to about 10% by weight. The beverage can also be fortified with one or more vitamins and minerals.

### BACKGROUND

The present disclosure generally relates to nutritional products. More specifically, the present disclosure is directed to ready to drink (“RTD”) beverages.

The chocolate beverages market is increasing with ready to drink beverages growing faster than the powders. Chocolate beverages can be in liquid or powder forms. One of the disadvantages of using powder form includes difficulties in dissolving the powder during hydration and the possibility of having a non-homogeneous beverage. RTD chocolate beverages can overcome the issues associated with powder forms. Among RTD beverages, there are beverages in extended shelf life (“ESL”) and aseptic form. ESL beverages generally have shorter shelf lives than aseptic beverages and also need to be stored at refrigeration temperatures.

A desired chocolate beverage should be shelf-stable during storage without phase separation, creaming, gelation and sedimentation, and retain a constant viscosity over time. Because emulsions and suspensions are thermodynamically unstable, there are challenges in overcoming physico-chemical instability issues associated with dairy-based chocolate RTD beverages (e.g., which contain proteins, carbohydrates, fat, insoluble materials such as cocoa, etc.) for long storage time, especially at elevated temperatures (e.g. 30° C.).

It is also desirable to have an aseptic, shelf-stable fortified RTD dairy-based chocolate beverage. Vitamins are essential for the normal growth and development of humans. However, the addition of vitamins to beverages can create a number of issues such as discoloration and/or an unpleasant texture and mouthfeel.

Minerals such as calcium and magnesium sources currently used for fortification may be soluble or substantially insoluble at around neutral pH. The addition of calcium or magnesium to dairy beverages presents significant problems. First, if soluble sources of calcium and/or magnesium (calcium chloride, etc.) are used, a high level of the metal ions leads to destabilization of proteins (e.g., coagulation) in the beverage and to undesirable flavors. Second, insoluble sources of calcium will not cause destabilization of protein micelles but will precipitate out of the solution rapidly.

Problems caused by iron sources added to food and beverages are color and off-flavor production, especially in the presence of oxygen, light and high temperature. As a result, the addition of iron to beverages, especially chocolate and/or milk containing drinks, can be very difficult. If soluble sources of iron are used, interaction between the iron and iron sensitive ingredients, such as polyphenols, occurs. For example, the addition of ferrous sulfate or other soluble iron salts cause chocolate containing beverages to acceptably turn dark grey.

Another problem with iron fortification is the capacity of iron to promote destructive free-radical reactions, which can result in off-flavors. Thus, the addition of soluble iron sources to fat containing products—mostly products with a high level of unsaturated fatty acids—can cause flavor changes due to lipid oxidation. Iron promoted oxidation not only affects the organoleptic properties of foods and beverages, but also undesirably affects the nutritional quality of these products. These interactions can be also enhanced during heat treatment, such as pasteurization or sterilization. Although some insoluble iron compounds do not cause color and/or off-flavor issues, it can still be difficult to keep the iron sources suspended without affecting the organoleptic properties of the fortified beverages, especially during a long storage time.

### SUMMARY

The present disclosure generally relates to chocolate beverages and fortified chocolate beverages. The chocolate beverages can be aseptic and ready to drink and have good physico-chemical stability during ambient storage times (e.g., stable for up to 12 months at 20° C. and up to 9 months at 30° C.) along with a pleasant mouthfeel. The chocolate beverages can also overcome problems with phase separation such as sedimentation, syneresis, creaming, viscosity change, age gelation, and other phase separation/instability issues during different storage conditions over the full life of the chocolate beverages.

In a general embodiment, the present disclosure provides a beverage including water, a cocoa component, and a stabilizing system. The stabilizing system includes a cellulose component including a blend of microcrystalline cellulose and carboxymethylcellulose in an amount ranging from about 0.03% to about 1% by weight, a gum, and an emulsifier ranging from about 0.1% to about 10% by weight. The % weights herein are based on the total weight of the beverage unless specified otherwise.

The weight ratio between the cellulose component and the gum can range from about 1:0.01 to about 1:30. The weight ratio of the microcrystalline cellulose to carboxymethylcellulose can range from about 9:1 to about 1:2. In an embodiment, the water has a total hardness of less than about 10 ppm.

In an embodiment, the gum can be kappa carrageenan, lambda carrageenan, iota carrageenan or a combination thereof. The gum can range from about 0.01% to about 0.9% by weight.

In an embodiment, the emulsifier is a protein-based emulsifier such as sodium caseinate, casein, soy protein, whey protein or a combination thereof. The emulsifier can be sodium caseinate ranging from about 0.4% to about 9% by weight. In another embodiment, the emulsifier is whey protein ranging from about 0.09% to about 3%.

In an embodiment, the cocoa component is natural cocoa, alkalized cocoa or a combination thereof. The cocoa component can range from about 0.3% to about 5% by weight.

In an embodiment, the beverage further includes a starch and/or one or more vitamins, minerals, amino acids, and prebiotics. The minerals can range from about 0.0025% to about 1% by weight. The vitamins can range from about 0.01% to about 0.5% by weight.

In another embodiment, the present disclosure provides an aseptic chocolate beverage comprising water, a cocoa component, and a stabilizing system. The stabilizing system includes a cellulose component, a gum, and an emulsifier. The stabilizing system maintains the aseptic chocolate beverage in a homogenous state for at least twelve months at 20° C., nine months at 30° C. and three month at 38° C. As used herein, the term homogenous state refers to being at least 95% homogenous (e.g., without heterogeneous elements or sedimentation within the beverage).

In an alternative embodiment, the present disclosure provides a beverage including water, a cocoa component ranging from about 0.3% to about 5% by weight, a starch ranging from about 0.05% to about 5% by weight, at least one of a vitamin and a mineral, and a stabilizing system. The stabilizing system has a cellulose component including a blend of microcrystalline cellulose and carboxymethylcellulose in an amount ranging from about 0.03% to about 2% by weight, a gum ranging from about 0.01% to about 1% by weight, and an emulsifier ranging from about 0.09% to about 10% by weight. The weight ratio among the cellulose component:gum:starch can be 1:(0.005-33):(0.025-167). The weight ratio of the microcrystalline cellulose to carboxymethylcellulose can range from about 10:1 to about 1:4.

An advantage of the present disclosure to provide an improved ready to drink stable chocolate beverage.

Another advantage of the present disclosure is to provide an improved ready to drink fortified chocolate beverage.

Still another advantage of the present disclosure is to provide a chocolate beverage that does not have stability issues such as sedimentation, syneresis, creaming, viscosity change, and age gelation during storage.

Yet another advantage of the present disclosure is to provide a chocolate beverage that maintains a good mouthfeel, body, smooth texture, and good flavor without off-notes during the shelf-life.

Another advantage of the present disclosure is to provide a chocolate beverage where the addition of vitamins does not cause product discoloration.

Still another advantage of the present disclosure is to provide a fortified beverage that maintains a good mouthfeel, body, smooth texture, and good flavor without color change and off-notes during the shelf-life.

Additional features and advantages are described herein, and will be apparent from, the following Detailed Description.

### DETAILED DESCRIPTION

The present disclosure relates to chocolate beverages and fortified chocolate beverages. The chocolate beverages can be aseptic and shelf-stable dairy-based cocoa containing RTD beverages, for example, formed by the interaction of dairy proteins, cocoa, carbohydrates, and fats, and stabilized by the use of a complex stabilizing system containing specific combinations of a cellulose component, a carrageenan component and an emulsifier. The chocolate beverages can be shelf-stable for at least twelve months at 20° C., nine months at 30° C. and one month at 38° C.

A unique combination of components were surprisingly found for a stabilizing system that can provide aseptic RTD beverages with good physico-chemical stability during storage while also providing good mouthfeel and a pleasant, refreshing taste. The stabilizing system improves the stability of aseptic shelf-stable RTD cocoa containing beverages by helping to avoid phase separation, creaming, syneresis, etc., during the ambient storage of the beverage.

In a general embodiment, the present disclosure provides a beverage including water, a cocoa component, and a stabilizing system. The water added to the make the beverage can be treated/filtered water, e.g., reverse osmosis (“RO”) treated water, with a total hardness of less than 10 ppm (e.g., as CaCO₃). The cocoa component can include one or more natural cocoas, alkalized cocoas, and/or other cocoa or chocolate based products. In an embodiment, the beverage includes a cocoa component in an amount ranging from about 0.3% to about 5% by weight.

The stabilizing system can have a cellulose component including microcrystalline cellulose and carboxymethylcellulose in an amount ranging from about 0.03% to about 1% by weight, a gum, and an emulsifier ranging from about 0.1% to about 10% by weight. The cellulose component can assist in maintaining good suspension and emulsion stability, avoiding syneresis and other phase separation issues during the storage, and improving mouthfeel.

The chocolate beverage can be made aseptic to avoid or minimize spoiling. The stabilizing system can maintain the aseptic chocolate beverage in a homogenous state for at least twelve months at 20° C., nine months at 30° C. and three month at 38° C.

The weight ratio between the cellulose component and the gum can range from about 1:0.01 to about 1:30. The weight ratio of the microcrystalline cellulose to carboxymethylcellulose can range from about 9:1 to about 1:2.

The gum in the stabilizing system can help to maintain the cocoa component in suspension in an aqueous/dairy medium and to stabilize proteins. In an embodiment, the gum can be kappa carrageenan, lambda carrageenan, iota carrageenan or a combination thereof. The gum can range from about 0.01% to about 0.9% by weight. In an embodiment, the weight ratio of lambda carrageenan to kappa carrageenan ranges from about 10:1 to about 1:3.

It has been unexpectedly discovered in alternative embodiments that improved functionality is achieved when the stabilizing system includes the microcrystalline cellulose/carboxymethylcellulose blend in the previously specified ranges and weight ratios along with lambda carrageenan and kappa carrageenan. In an embodiment, the weight ratio of the cellulose component:carrageenan component can range from about 1:0.01 to about 1:30. Such combinations can result in significantly improved stability of cocoa in suspension while also preventing or minimizing other phase separation issues.

The emulsifier in the stabilizing system can further be used to maintain emulsion stability of the beverage during the storage and also to maintain the required mouthfeel. The emulsifier can be any suitable protein-based emulsifier. The emulsifier can range from about 0.09% to about 10% by weight. In an embodiment, the emulsifier is a protein-based emulsifier such as sodium caseinate, casein, soy protein, whey protein or a combination thereof. The emulsifier can be sodium caseinate ranging from about 0.4% to about 9% by weight. In another embodiment, the emulsifier is whey protein ranging from about 0.09% to about 3%.

The chocolate beverages can also include one or more ingredients such as flavors, sweeteners, colorants or a combination thereof. Sweeteners can include, for example, sucrose, sucralose, acesulfame K, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the beverage, the level and type of flavor used, and cost considerations. Any suitable combinations of sugar and/or sugarless sweeteners may be used in the chocolate beverages. In an embodiment, the sweetener is present in the chocolate beverage at a concentration ranging from about 0.001% to about 6% by weight. In another embodiment, the artificial sweetener is present in an amount ranging from about 0.001% to about 0.1% by weight.

Non-limiting examples of suitable flavors include chocolate enhancers, cream/dairy enhancers, vanilla flavors or a combination thereof. The flavor(s) can be present in an amount ranging from about 0.01% to about 5% by weight. In an embodiment, the chocolate beverage can have a total solid content ranging from about 7% to about 30%, preferably from about 10% to about 20%, and most preferably from about 13% to about 17% by weight.

The chocolate beverages can be made using any suitable process. For example, a process of making the chocolate beverages includes dissolving the raw materials in fluid milk/water and hydration (e.g., wetting) of a cocoa powder/component for 45 minutes to 90 minutes at about 90° C. to about 95° C. to form the beverage. The beverage can then be subjected to ultra high temperature (“UHT”) heat treatment at about 143° C. to about 151° C. for 5 seconds to 12 seconds and aseptic homogenization from about 30 bars to about 300 bars followed by aseptic filling of the beverage into a suitable container.

In an alternative embodiment, the present disclosure provides fortified RTD chocolate beverages that overcome phase separation issues (e.g., creaming, gelation, syneresis, coagulation and sedimentation, etc.) at refrigeration and ambient temperatures (e.g. 4° C., 20° C., 30° C., and 38° C.). For example, the fortified chocolate beverages can have minimal color change and precipitation and can be shelf stable for at least 12 months at 4° C. and 20° C., 9 months at 30° C. and 1 months at 38° C.

In an embodiment, the beverage further includes one or more starches. The starch can help to maintain good suspension stability, avoid syneresis and other phase separation issues during the storage, and improve mouthfeel. The starch can be, for example, corn starch, rice starch, potato starch or a combination of different starches. In a preferred embodiment, the starch level ranges from about 0.05% to about 5% by weight of composition.

In an embodiment, the beverage further includes one or more vitamins and/or minerals. The vitamins can be in an amount ranging from about 0.01% to about 0.5% by weight. The vitamins include, but are not limited to, vitamin C and group B vitamins. Non-limiting examples of suitable vitamins include ascorbic acid, ascorbyl palmitate, vitamins B1, B2, B6, B12, and Niacin (B3), or combination of thereof. The vitamins may also include Vitamins A, D, E and K and acid vitamins such as pantothenic acid and folic acid and biotin.

The minerals can be in an amount ranging from about 0.0025% to about 1% by weight. Non-limiting examples of the minerals include calcium, magnesium, iron or a combination thereof. The source of calcium can include calcium carbonate, calcium phosphate, calcium citrate, other insoluble calcium compounds or a combination thereof. The source of magnesium can include magnesium phosphate, magnesium carbonate, magnesium hydroxide or combination of thereof. The source of iron can include iron ammonium phosphate, ferric pyrophosphate, ferric phosphate, ferrous phosphate, other insoluble iron compounds, aminoacids, iron chelating compounds such as EDTA, or combination of thereof. The minerals may also include zinc, iodine, copper, phosphorus, manganese, potassium, chromium, molybdenum, selenium, nickel, tin, silicon, vanadium and boron.

In an embodiment, the chocolate beverage further includes one or more amino acids. Non-limiting examples of amino acids include Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Histidine or a combination thereof

In another embodiment, the chocolate beverage further one or more prebiotics. Non-limiting examples of prebiotics include fructooligosaccharides, inulin, lactulose, galactooligosaccharides, acacia gum, soyoligosaccharides, xylooligosaccharides, isomaltooligosaccharides, gentiooligosaccharides, lactosucrose, glucooligosaccharides, pecticoligosaccharides, resistant starches, sugar alcohols or a combination thereof

In an alternative embodiment, the present disclosure provides a fortified chocolate beverage including water, a cocoa component ranging from about 0.3% to about 5% by weight, a starch ranging from about 0.05% to about 5% by weight, at least one of a vitamin and a mineral, and a stabilizing system. The stabilizing system has a cellulose component including a blend of microcrystalline cellulose and carboxymethylcellulose in an amount ranging from about 0.03% to about 1% by weight, a gum ranging from about 0.01% to about 1% by weight, and an emulsifier ranging from about 0.09% to about 10% by weight. The weight ratio among the cellulose component:gum:starch is 1:(0.005-33):(0.025-167). The weight ratio of the microcrystalline cellulose to carboxymethylcellulose can range from about 10:1 to about 1:4. The gum can be a combination of different gums such as kappa carrageenan, lambda carrageenan, and/or iota carrageenan.

The process of making the beverages includes dissolution of the stabilizing system components (cellulose component and gum) in water and /or fluid milk, hydration (wetting) of cocoa powder in water for 45 minutes to 90 min@90° C.-95° C., UHT heat treatment at 143° C. to 151° C. for 5 sec to 12 sec, followed by aseptic homogenization from 50 bars to 300 bars and aseptic filling according to known methods.

### EXAMPLES

By way of example and not limitation, the following examples are illustrative of various embodiments of the present disclosure.

### Example 1

In a first tank, 1.3 kg of cocoa powder were hydrated during 90 min at about 90° C. under continuous agitation. 50 g of carrageenan and 250 g of microcrystalline cellulose/carboxymethylcellulose (MCC/CMC) were dry blended with 3.85 kg of sucrose. The dry blend was then poured under high agitation into a second tank containing 35 kg of reverse osmosis (RO) water and 55 kg of skim milk. 3.75 kg milk cream, 0.1 kg of whey protein powder, 30 g of citric acid, 10 g of sweetener sucralose, 9 g of sodium chloride and 240 g of flavors were added under continuous high agitation into the second tank. Then, the hydrated cocoa was transferred from the first tank into the second tank under continuous high agitation. Additional RO water was added to adjust the total product weight to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

The aseptic beverage was stored for 1 month at 38° C., 9 months at 30° C. and 12 months at 20° C.

Beverage physico-chemical stability was judged by non-trained panelists. No phase separation such as syneresis, gelation, marbleling and practically no sedimentation were found during the storage.

It was found that the chocolate drink has good appearance, mouth-feel, smooth texture and a good flavor without “off” taste.

### Example 2

In a first tank, 1.3 kg of cocoa powder were hydrated during 90 min at about 90° C. under continuous agitation. 50 g of carrageenan and 250 g of microcrystalline cellulose/carboxymethylcellulose (MCC/CMC) were dry blended with 3.85 kg of sucrose. The dry blend was then poured under high agitation into a second tank containing 80 kg of reverse osmosis (RO) water. 5.6 kg of milk powder (28% fat), 3.0 kg skim milk powder, 0.1 kg of whey protein powder, 30 g of citric acid, 10 g of sweetener sucralose, 9 g of sodium chloride and 270 g of flavors were mixed under continuous high agitation into the second tank. Then, the hydrated cocoa was transferred from the first tank into the second tank under continuous high agitation. Additional RO water was added to adjust the total product weight to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

The aseptic beverages were stored for 3 month at 38° C., 6 months at 30° C. and 9 months at 20° C.

Beverage physico-chemical stability was judged by non-trained panelists. No phase separation such as syneresis, gelation, marbleling and practically no sedimentation were found during the storage.

It was found that the chocolate drink has good appearance, mouth-feel, smooth texture and a good flavor without “off” taste.

### Example 3

In a first tank, 1.4 kg of cocoa powder were hydrated during 90 min at about 90° C. under continuous agitation. 20 g of kappa-carrageenan, 100 g of iota-carrageenan and 300 g of microcrystalline cellulose / carboxymethylcellulose (MCC/CMC) were dry blended with 3.85 kg of sucrose. The dry blend was then poured under high agitation into a second tank containing 40 kg of reverse osmosis (RO) water and 45 kg of whole pasteurized milk. 3.0 kg of skim milk powder, 0.1 kg of whey protein powder, 0.03 kg of citric acid and 0.27 kg of flavors were mixed under continuous high agitation into the second tank. Then, the hydrated cocoa was transferred from the first tank into the second tank under continuous high agitation. Additional RO water was added to adjust the total product weight to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

The aseptic beverages were stored for 3 month at 38° C., 6 months at 30° C. and 9 months at 20° C.

Beverage physico-chemical stability was judged by non-trained panelists. No phase separation including syneresis, gelation, marbleling and practically no sedimentation were found during the storage.

It was found that the chocolate drink has good appearance, mouth-feel, smooth texture and a good flavor without “off” taste.

### Example 4

A chocolate beverage was prepared as in Example 3 but using 20 g of microcrystalline cellulose/carboxymethylcellulose.

The aseptic beverages were stored at 38, 30 and 20° C.

Beverage physico-chemical stability was judged by non-trained panelists. Significant phase separation, including severe sedimentation was observed in beverages (at all storage temperatures) even after only one month of storage.

### Example 5

A chocolate beverage was prepared as in Example 3 but using 1.1 kg of microcrystalline cellulose/and carboxymethylcellulose.

The aseptic beverages were stored at 38, 30 and 20° C.

Beverage physico-chemical stability was judged by non-trained panelists. Gelation and undesirable mouthfeel were observed in the chocolate beverages only a few days after production (at all storage temperatures).

### Example 6

A chocolate beverage was prepared as in Example 3 but using 1.0 kg of kappa-carrageenan and iota carrageenan blend (at 1:3 ratio of kappa- to iota-carrageenan, respectively.

The aseptic beverages were stored at 38, 30 and 20° C.

Beverage physico-chemical stability was judged by non-trained panelists. A severe syneresis was observed in the chocolate beverages after few weeks of storage (at all storage temperatures). Degree of the phase separation was found to be higher at higher storage temperatures.

### Example 7

A chocolate beverage was prepared as in Example 3 but using 8 g of kappa-carrageenan and iota carrageenan blend (at 1:3 ratio of kappa- to iota-carrageenan, respectively.

The aseptic beverages were stored at 38, 30 and 20° C.

Beverage physico-chemical stability was judged by non-trained panelists. A severe sedimentation was observed in the chocolate beverages after 1 month of storage (at all storage temperatures). Degree of the sedimentation was found to be higher at higher storage temperatures.

### Example 8

In a first tank, 1.6 kg of cocoa powder were hydrated during 90 min at about 90° C. under continuous agitation. 50 g of carrageenan and 220 g of microcrystalline cellulose/carboxymethylcellulose (MCC/CMC) were dry blended with 3.85 kg of sucrose. The dry blend was then poured under high agitation into a second tank containing 35 kg of RO water and 55 kg of skim milk. 3.75 kg milk cream liquid (40% fat), 0.1 kg of whey protein powder, 170 g of di-potassium phosphate, 35 g of citric acid, 10 g of sweetener sucralose, 9 g of sodium chloride, 4 g of anhydrous iron pyrophosphate, 50 g of magnesium carbonate, 8 g of sodium ascorbate, 40 g of vitamin RTD premix and 70 g of flavors were mixed under continuous high agitation into the second tank. Then, the hydrated cocoa was transferred from the first tank into the second tank under continuous high agitation. Additional RO water was added to adjust the total product weight to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

The aseptic beverages were stored for 3 month at 38° C., 6 months at 30° C. and 9 months at 20° C.

Beverage physico-chemical stability was judged by non-trained panelists. No phase separation such as syneresis, gelation, marbleling and practically no sedimentation were found during the storage.

It was found that the chocolate drink has good appearance, mouth-feel, smooth texture and a good flavor without “off” taste.

### Example 9

In a first tank, 1.6 kg of cocoa powder were hydrated during 90 min at about 90° C. under continuous agitation. 75 g of carrageenan and 110 g of microcrystalline cellulose / carboxymethylcellulose (MCC/CMC) and 0.5 kg of starch Thermflo were dry blended with 3.85 kg of sucrose. The dry blend was then poured under high agitation into a second tank containing 39 kg of RO water and 45 kg of whole milk. 3.0 kg skim milk powder, 0.1 kg of whey protein powder, 170 g of di-calcium phosphate, 35 g of citric acid, 10 g of sweetener sucralose, 9 g of sodium chloride, 4 g of anhydrous iron pyrophosphate, 49 g of magnesium carbonate, 8 g of sodium ascorbate, 40 g of vitamin RTD premix and 70 g of flavors were mixed under continuous high agitation into the second tank. Then, the hydrated cocoa was transferred from the first tank into the second tank under continuous high agitation. Additional RO water was added to adjust the total product weight to 100 kg.

The liquid was pre-heated at 78±5° C., UHT treated for 5 sec at 150° C., cooled to 78±5° C., homogenized at 200/50 bar, cooled to 20° C. and then aseptically filled into PET bottles. The beverage can be aseptically filled in any aseptic containers, e.g. Tetra Paks, jars, jugs or pouches.

The aseptic beverages were stored for 3 month at 38° C., 6 months at 30° C. and 9 months at 20° C.

Beverage physico-chemical stability was judged by non-trained panelists. No phase separation such as syneresis, gelation, marbleling and practically no sedimentation were found during the storage.

It was found that the chocolate drink has good appearance, mouth-feel, smooth texture and a good flavor without “off” taste.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A beverage comprising:
water;
a cocoa component; and
a stabilizing system comprising a cellulose component comprising microcrystalline cellulose and carboxymethylcellulose in an amount of about 0.03% to about 1% by weight of the product, a gum, a weight ratio between the cellulose component and the gum is about 1:0.01 to about 1:30, and an emulsifier comprising about 0.09% to about 10% by weight of the product.

2. The beverage of claim 1, wherein the water has a total hardness of less than about 10 ppm.

3. The beverage of claim 1, wherein the weight ratio of the microcrystalline cellulose to carboxymethylcellulose is about 9:1 to about 1:2.

4. The beverage of claim 1, wherein the gum is selected from the group consisting of kappa carrageenan, lambda carrageenan, iota carrageenan and combinations thereof.

5. The beverage of claim 1, wherein the gum comprises about 0.01% to about 0.9% by weight of the beverage.

6. The beverage of claim 1, wherein the emulsifier is a protein-based emulsifier selected from the group consisting of sodium caseinate, casein, soy protein, whey protein and combinations thereof.

7. The beverage of claim 1, wherein the emulsifier is sodium caseinate comprising about 0.4% to about 9% by weight of the beverage.

8. The beverage of claim 1, wherein the emulsifier is whey protein comprising about 0.09% to about 3% by weight of the beverage.

9. The beverage of claim 1, wherein the cocoa component is selected from the group consisting of natural cocoa, alkalized cocoa and combinations thereof.

10. The beverage of claim 1, wherein the cocoa component comprises about 0.3% to about 5% by weight of the product.

11. The beverage of claim 1 comprising a starch and at least one component selected from the group consisting of a vitamin, a mineral, an amino acid, and a prebiotic.

12. The beverage of claim 11, wherein the vitamin comprises about 0.01% to about 0.5% by weight of the beverage and the mineral comprises about 0.0025% to about 1% by weight of the beverage.

13. An aseptic chocolate beverage comprising:
water;
a cocoa component; and
a stabilizing system comprising a cellulose component, a gum, and an emulsifier, wherein the stabilizing system maintains the aseptic chocolate beverage in a homogenous state for at least twelve months at 20° C., nine months at 30° C. and three month at 38° C.

14. A beverage comprising:
water;
a cocoa component comprising about 0.3% to about 5% by weight of the beverage;
a starch comprising about 0.05% to about 5% by weight of the beverage;
at least one component selected from the group consisting of a vitamin and a mineral; and
a stabilizing system comprising a cellulose component comprising microcrystalline cellulose and carboxymethylcellulose comprising about 0.03% to about 2% by weight of the beverage,
a gum comprising about 0.01% to about 1% by weight, wherein a weight ratio among of the cellulose component:gum:starch is 1:(0.005-33):(0.025-167), and
an emulsifier comprising about 0.09% to about 10% by weight of the beverage.

15. The beverage of claim 14, wherein the weight ratio of the microcrystalline cellulose to carboxymethylcellulose is about 10:1 to about 1:4.
